(19) United States
(12) Patent Application Publication
(10) Pub. No.: US 2006/0216005 A1
(43) Pub. Date: Sep. 28, 2006

(54) Lens-fitted photographic film unit

(75) Inventor: Mitsuhiro Moriya, Minami-Ashigara-Shi (JP)

Correspondence Address: YOUNG & THOMPSON, 745 SOUTH 23RD STREET, 2ND FLOOR, ARLINGTON, VA, 22202, US

(73) Assignee: FUJI PHOTO FILM CO., LTD., MINAMI-ASHIGARA-SHI (JP)

(21) Appl. No.: 11/387,927

(22) Filed: Mar. 24, 2006

(30) Foreign Application Priority Data
Mar. 25, 2005 (JP) 2005-090044

(51) Int. Cl. G03B 17/02

(52) U.S. Cl. 396/6; 396/166

(57) ABSTRACT

There is disclosed a lens-fitted photographic film unit preloaded with an unexposed photographic film. A light regulating filter is disposed between the photographic film and a shutter blade. Light from a subject is applied to the light regulating filter only when the shutter blade is opened. The light regulating filter is obtained by coating a base with an electrochromic material, and light transmittance thereof is changed depending on a voltage to be applied. When a photometric switch is turned on, a photometric circuit measures brightness of the subject. According to the brightness of the subject, a controller controls the voltage to be applied to the light regulating filter.

### BACKGROUND OF THE INVENTION

1. Field of the Invention

The present invention relates to a lens-fitted photographic film unit having a function of controlling exposure.

2. Background Arts

There has been known a lens-fitted photographic film unit into which an unexposed photographic film is preloaded in a factory. The lens-fitted photographic film unit is widely spread because it is available and easy to operate. Since the lens-fitted photographic film unit is generally easy to operate and reasonable on the plus side, the structure thereof is simplified while suppressing the manufacturing cost as much as possible.

For example, a lens-fitted photographic film unit for daylight photography available commercially is not provided with an aperture mechanism for controlling an exposure amount. Therefore, depending on the latitude of the photographic film, photography is performed with a correct exposure under normal conditions for photographing. However, when the subject is considerably bright, over-exposure occurs. Additionally, when the subject is considerably dark, under-exposure occurs.

There are proposed techniques for using a photochromic material (see Japanese Patent Application Laid-open No. Hei 6-317815, Japanese Patent Application Laid-open No. Hei 9-203918, and Japanese Patent Application Laid-open No. Hei 11-352642, for example) or an electrochromic material (See Japanese Patent Application Laid-open No. 2003-295227 and Japanese Patent Application Laid-open No. 2004-170613, for example) as a light regulating member or light adjuster instead of the aperture mechanism. Japanese Patent Application Laid-open No. Hei 6-317815 describes, for example, a lens-fitted photographic film unit in which the photochromic material is used for decreasing the exposure amount when the subject is bright. Further, Japanese Patent Application Laid-open No. 2004-170613 describes a lens-fitted photographic film unit in which light transmittance of the electrochromic material is changed based on magnitude of electromotive force caused by electromagnetic waves and light, to control exposure amount.

In the conventional lens-fitted photographic film unit, the light regulating member obtained by coating the base with the electrochromic material is secured to a lens holder. In front of the lens holder, a tubular portion is disposed. Inside the tubular portion, a taking lens is contained. A lens holding portion is attached to the tubular portion of the lens holder from above. The lens holding portion is positioned so as to fit into the aperture of a front cover. Therefore, it is very likely that an impact applied to the front cover is applied to the lens holder. Since the base of the light regulating member is made of glass or the like, there is a problem in that the light regulating member is likely to be damaged upon receiving a high impact applied to the front cover or the like.

Further, in the conventional lens-fitted photographic film unit, the light regulating member is located at a position where the subject light is always applied thereto through the taking lens. Accordingly, the electorochromic material deteriorates due to the ultraviolet rays. When the electorochromic material deteriorates due to the ultraviolet rays, there may arise a deviation in the relation between magnitude of the voltage to be applied and the light transmission amount of the subject light. As a result, it is impossible to control exposure correctly, and there is a problem in that over-exposure or under-exposure is likely to occur on photographed pictures.

### SUMMARY OF THE INVENTION

In view of the foregoing, a main object of the present invention is to provide a lens-fitted photographic film unit capable of preventing a light regulating member or light adjuster from being damaged. Another object of the present invention is to provide a lens-fitted photographic film unit capable of preventing deterioration of the light regulating member due to ultraviolet rays to control exposure correctly.

To achieve the above and other objects, a lens-fitted photographic film-unit of the present invention includes a shutter device, a light regulating member or light adjuster, and a controlling device. The shutter device has a shutter blade swingable between an opening position and a closing position. The light regulating member is provided behind the shutter device. When the shutter blade is located at the opening position, subject light is applied to the light regulating member. The light regulating member changes light transmittance of the subject light depending on magnitude of voltage to be applied thereto. The controlling device adjusts a voltage to be applied to the light regulating member depending on brightness of the subject.

In a preferred embodiment of the present invention, the light regulating member is provided inside a dark box or exposure tunnel. Further, the light regulating member is composed of a base and an electrochromic material coated on the base.

According to the present invention, since the light regulating member is disposed behind the shutter device, light is not applied to the light regulating member when photography is not performed. Therefore, it is possible to prevent deterioration of the light transmission performance of the light regulating member due to ultraviolet rays. As a result, it is possible to perform photography with correct exposure. Additionally, since life-span extension of the light regulating member can be achieved, it is possible to spare the troublesome time for replacing the light regulating member in reusing the lens-fitted photographic film unit and achieve reduction in manufacturing cost.

Further, since the lens holder and the light regulating member are disposed separately, an impact applied to the front cover or the like is not directly applied to the light regulating member. Therefore, it is possible to prevent the light regulating member from being damaged upon receiving an impact applied to the front cover or the like.

According to the present invention, since a main body provided with the dark box having the light regulating member and the like can be used as a common member, it is possible to achieve reduction in manufacturing cost. Further, it is possible to facilitate the replacement of the light regulating filter in reusing the lens-fitted photographic film unit recovered.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is an external perspective view illustrating a lens-fitted photographic film unit according to an embodiment of the present invention;

FIG. 2 is an exploded perspective view illustrating constitution of the lens-fitted photographic film unit;

FIG. 3 is a cross-sectional view illustrating the internal constitution of the lens-fitted photographic film unit;

FIG. 4 is a diagram illustrating electrical constitution of the lens-fitted photographic film unit;

FIG. 5 is a flowchart illustrating a procedure of process performed in a control circuit; and

FIG. 6 is a cross-sectional view illustrating internal constitution of a lens-fitted photographic film unit according to another embodiment of the present invention.

### DETAILED DESCRIPTION OF THE EMBODIMENTS

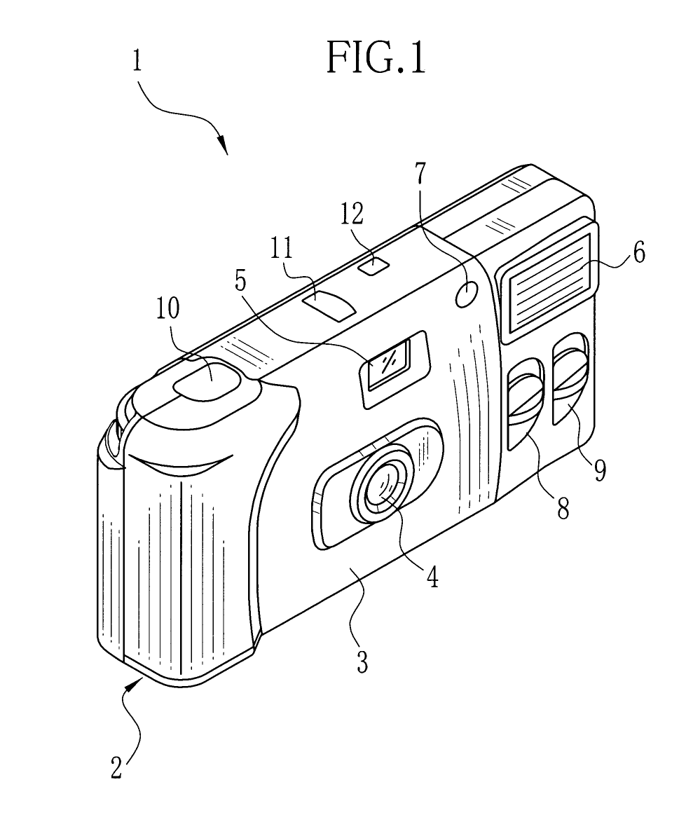

As shown in FIG. 1, a lens-fitted photographic film unit 1 of the present invention is composed of a unit body 2 and a label 3 partially covering the unit body 2. A front surface of the unit body 2 includes a taking lens 4, a viewfinder window 5, an electronic flash device 6, a photometric window 7, an electronic flash switch 8, a photometric switch 9, and the like. An upper surface of the unit body 2 includes a release button 10, a counter window 11 for displaying an available frame number, and a light guide 12 for displaying completion of charging.

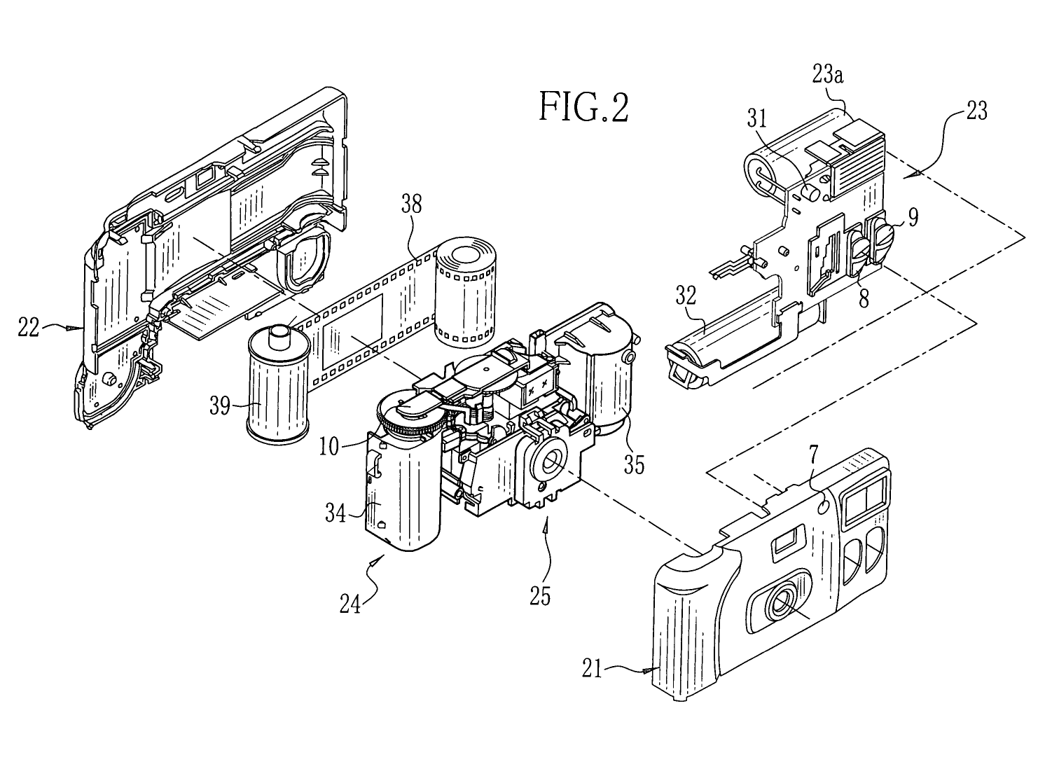

As shown in FIG. 2, the unit body 2 is composed of front and rear covers 21 and 22, a circuit board 23, a main body 24, and an exposure unit 25. The front cover 21 covers a front surface of the main body 24. The front cover 21 has various apertures for uncovering the taking lens 4, the viewfinder window 5, the electronic flash device 6, the photometric window 7, the electronic flash switch 8, and the photometric switch 9.

The circuit board 23 includes the electronic flash device 6, a photometric device or photometric element 31, the electronic flash switch 8, and the photometric switch 9. A battery 32 is disposed at a lower portion of the circuit board 23. The electronic flash device 6 emits flash light in synchronism with a shutter device to measure brightness of the subject. The photometric device 31 is a photodiode, for example. The photometric device 31 fits into the photometric window 7 of the front cover 21. It is noted that the photometric device 31 may be a material other than the photodiode.

The electronic flash switch 8 is turned on upon being slid upward, and turned off upon being slid downward. The photometric switch 9 is turned on upon being slid upward, and turned off upon being slid downward.

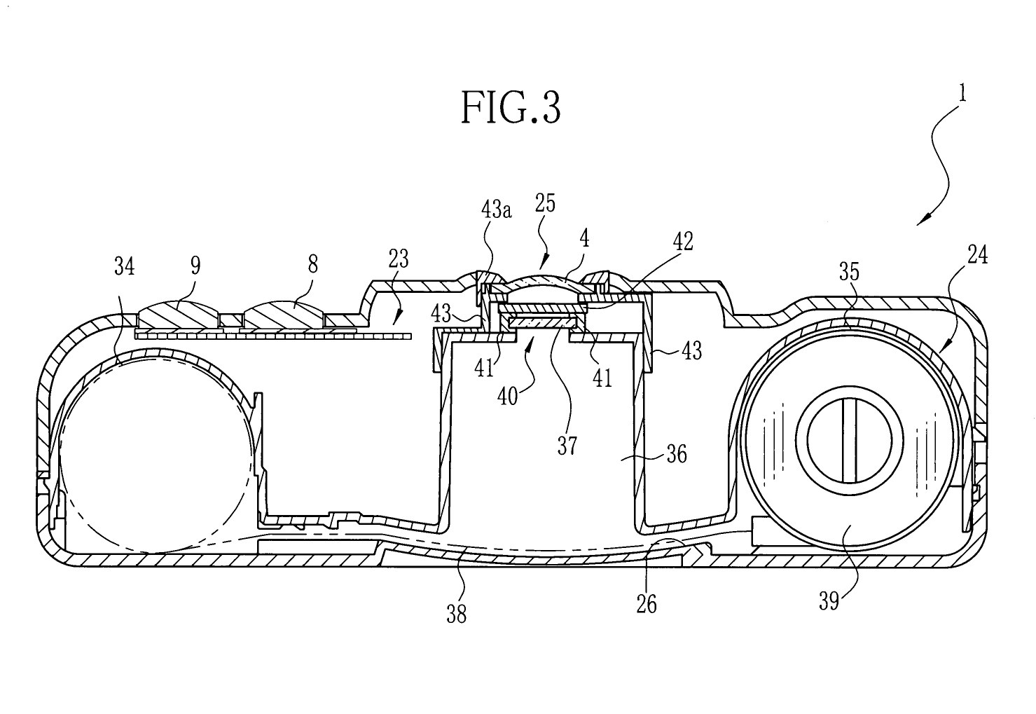

The main body 24 is integrated together with a film roll chamber 34 and a cartridge chamber 35. The film roll chamber 34 contains an unused portion of a film 38 in a rolled manner. The cartridge chamber 35 is loaded with a film cartridge 39 for winding picture frames after being photographed. The rear cover 22 is attached to the rear surface of the main body 24 to cover the rear surface of the main body 24 in light-tight fashion. The rear cover 22 includes a film path 26 (see FIG. 3). The film path 26 is disposed between the film roll chamber 34 and the cartridge chamber 35.

As shown in FIG. 3, the main body 24 includes a dark box or exposure tunnel 36 disposed between the film roll chamber 34 and the cartridge chamber 35. A front surface of the dark box 36 has an exposure aperture 40. In photography, a shutter blade 42 of the shutter device is shifted from a closing position to an opening position. As described above, while the shutter blade 42 is shifted to the opening position, the subject light enters into the dark box 36 through the exposure aperture 40 to expose the film 38. Base frames 41, which hold a light adjusting filter or regulating filter 37, are disposed at the front surface side of the dark box 36.

The light regulating filter 37 is obtained by coating a surface of a support having translucency such as a glass plate with an electrochromic material. The light regulating filter 37 is disposed behind the shutter blade 42. Accordingly, while the shutter blade 42 is located at the opening position, the subject light reaches the film 38 through the light regulating filter 37. While the shutter blade 42 is located at the closing position, the light regulating filter 37 is shielded from the light.

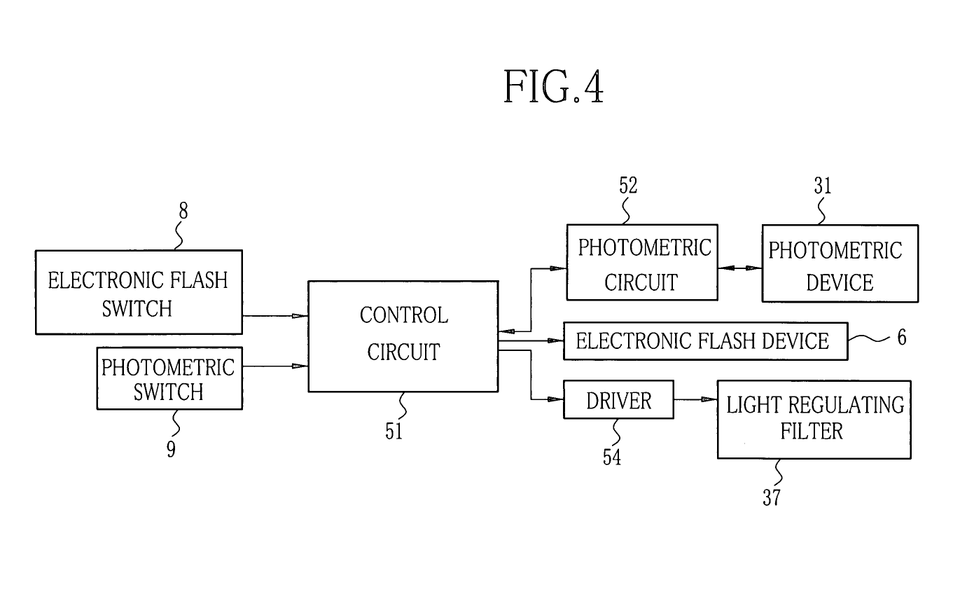

The dimension of the light regulating filter 37 is approximately equal to or slightly smaller than that of the shutter blade 42. It is noted that the light regulating filter 37 includes an electrode (not shown). The electrode is connected with a driver 54 to be described later (see FIG. 4). A voltage outputted from the driver 54 is applied to the electrode. The support may be one having optical characteristics which does not hinder focusing performance of the taking lens 4 and brightness from a practical standpoint, including synthetic resin such as acrylate resin in addition to the glass described above.

The exposure unit 25 is composed of the taking lens 4, the shutter device (the shutter blade) 42, and a lens holder 43. The taking lens 4 and the shutter device are incorporated into the lens holder 43. The taking lens 4 is secured to a front surface of the exposure unit 25. When the front cover 21 is attached to the main body 24, the taking lens 4 is uncovered through the aperture of the front cover 21. The shutter device is of a kick type, for example. The shutter blade 42 is located at the closing position for closing the exposure aperture 40 when photography is not performed. Upon pressing the release button 10, the shutter blade 42 is kicked by a driving lever (not shown) to open the exposure aperture 40 for 1/125 seconds, for example. The lens holder 43 contains the taking lens 4 at its front side, and is fixed by lens holding portions 43a. The lens holding portions 43a fit into the aperture of the front cover 21 to perform positioning of the taking lens 4.

As shown in FIG. 4, the control circuit 51 is connected with the electronic flash switch 8, the photometric switch 9, the photometric circuit 52, the electronic flash circuit 53, and the driver 54.

A rear surface of the electronic flash switch 8 has a metal contact facing the circuit board 23. When the electronic flash switch 8 is slid upward, the metal contact of the electronic flash switch 8 is electrically connected to a metal contact of the circuit board 23 and turned on. In contrast, when the electronic flash switch 8 is slid downward, the metal contact of the electronic flash switch 8 moves away from the metal contact of the circuit board 23 and turned off.

A rear surface of the photometric switch 9 has a metal contact facing the circuit board 23. When the photometric switch 9 is slid upward, the metal contact of the photometric switch 9 is electrically connected to a metal contact of the circuit board 23 and turned on. In contrast, when the photometric switch 9 is slid downward, the metal contact of the photometric switch 9 moves away from the metal contact of the circuit board 23 and turned off.

The photometric circuit 52 is activated when the photometric switch 9 is turned on. The photometric circuit 52 measures the subject light by use of the photometric device 31. Thereafter, the photometric circuit 52 outputs the resulting photometric data of the subject light to the control circuit 51.

The electronic flash device 6 is composed of a charging circuit, a main capacitor 23a (see FIG. 2), a flash discharge tube, and a trigger switch. The electronic flash device 6 is activated when the electronic flash switch 8 is turned on. The charging circuit charges the capacitor. When the release button 10 is pressed after completion of the charging, the flash discharge tube emits flash light in synchronism with the shutter device.

The driver 54 is connected with an electrode of the light regulating filter 37, and applies a voltage to the electrode of the light regulating filter 37. The photometric circuit 52 measures a detection signal. Based on the detection signal, the control circuit 51 applies a voltage to the electrode of the light regulating filter 37 through the intermediation of the driver 54. The light regulating filter 37 changes the light transmission amount of the subject light corresponding to the applied voltage.

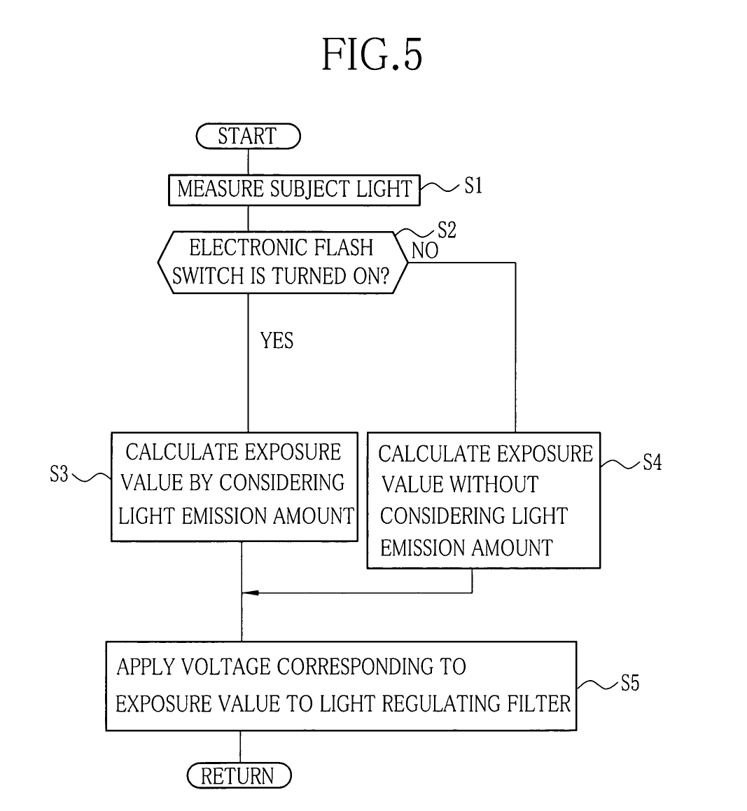

Next, referring to FIG. 5, the controlling of exposure is explained. When the photometric switch 9 is turned on, the control circuit 51 causes the photometric circuit 52 to measure the subject light (step S1). The photometric circuit 52 uses the photometric device 31 to measure the subject light through the photometric window 7. The resulting photometric data is transmitted from the photometric circuit 52 to the control circuit 51. Next, the control circuit 51 determines whether the electronic flash switch 8 is turned on (step S2).

When the electronic flash switch 8 is in an on-state in step S2, the control circuit 51 calculates an optimum exposure value by considering the light emission amount of the electronic flash device 6. The control circuit 51 calculates a voltage to be applied to the light regulating filter 37 in accordance with the exposure value (step S3). In contract, when the electronic flash switch 8 is in an off-state in step S2, the control circuit 51 calculates the optimum exposure value for daylight photography. The control circuit 51 calculates a voltage to be applied to the light regulating filter 37 in accordance with the exposure value (step S4).

Next, the control circuit 51 outputs the control signal corresponding to the voltage calculated in step S3 or step S4 to the driver 54. The driver 54 applies the voltage corresponding to the control signal to the light regulating filter 37 (step S5). So the transmittance of the light regulating filter 37 can be set at an adjusted level.

As described above, according to the lens-fitted photographic film unit of this embodiment, the subject light is not applied to the light regulating filter when photography is not performed, thus preventing deterioration of the light regulating filter due to ultraviolet rays. Accordingly, it is possible to prevent incorrect exposure due to deterioration of performance of the light regulating filter.

Further, according to the lens-fitted photographic film unit of this embodiment, since the base frames disposed at the front surface side of the dark box or exposure tunnel hold the light regulating filter, an impact applied to the front cover is not directly applied to the base frame. Therefore, it is possible to prevent the light regulating filter from being damaged.

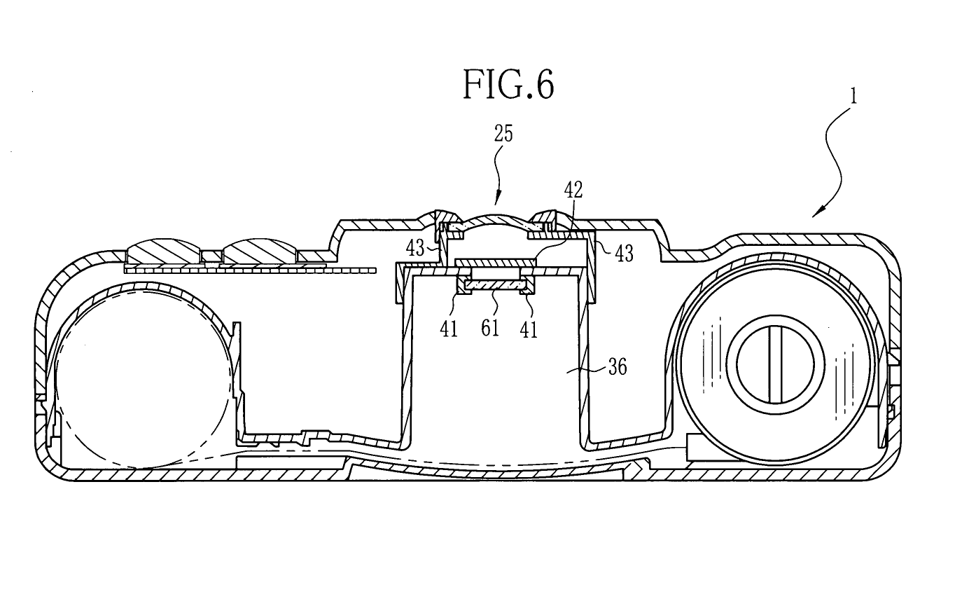

It is noted that, according to the above embodiment, the light regulating filter is disposed between the shutter device and the dark box. However, the present invention is not limited thereto. As shown in FIG. 6, for example, a light adjusting filter or regulating filter 61 may be disposed inside the dark box 36. Since the inside of the dark box 36 completely blocks light so as not to expose the film 38, it is possible more efficiently to prevent deterioration of the light regulating filter 37 due to ultraviolet rays. It is noted that, in FIG. 6, the components identical with those of the first embodiment are designated by the same reference numerals as used in the description of the first embodiment, and a detailed description thereof will be omitted.

In a second embodiment, it is possible to facilitate the replacement of the light regulating filter in reusing the lens-fitted photographic film unit recovered. Additionally, the main body may be produced as a common member, and a light regulating filter selected according to conditions including film sensitivity immediately before producing the lens-fitted photographic film unit may be disposed appropriately in the dark box. Accordingly, it is possible to eliminate the troublesome process of producing the main bodies of various types corresponding to the respective light regulating filters, thus achieving reduction in manufacturing cost.

The driving of the light regulating filter may be preformed at a predetermined interval during the on-state of the photometric switch. Alternatively, the driving of the light regulating filter may be performed only once when the photometric switch is turned on. In the latter case, the framing can be changed without changing the exposure value.

An electrochromic material has a memory function. Therefore, when the light transmittance of the light regulating filter is to be increased, the reverse voltage relative to the voltage which has been already applied to the light regulating filter is applied to the light regulating filter, to return the light transmittance to the initial value. Thereafter, a new voltage is applied to the light regulating filter. In contrast, when the light transmittance of the light regulating filter is to be decreased, the voltage which has been already applied to the light regulating filter is stored in the control circuit, and the difference between the stored voltage and a resulting voltage obtained by the additional measurement is calculated, thus applying a voltage corresponding to the difference to the light regulating filter.

Thus the present invention is not to be limited to the above embodiments but, on the contrary, various modifications will be possible without departing from the scope and spirit of the present invention as specified in claims appended hereto.

What is claimed is:

1. A lens-fitted photographic film unit preloaded with an unexposed photographic film comprising:
a shutter blade swingable between a closing position and an opening position, said photographic film being exposed by light from a subject at said opening position;
a light regulating member disposed between said shutter blade and said photographic film, light transmittance of said light regulating member being changed depending on a voltage; and
a driver for applying said voltage to said light regulating member.

2. A lens-fitted photographic film unit as defined in claim 1, said lens-fitted photographic film unit further comprising:
a photometric device for measuring brightness of said subject; and
a controller for controlling said driver so as to apply said voltage to said light regulating member in accordance with the brightness of said subject measured by said photometric device.

3. A lens-fitted photographic film unit as defined in claim 2, said lens-fitted photographic film unit further comprising a dark box disposed in front of said photographic film, said dark box being provided with said light regulating member.

4. A lens-fitted photographic film unit as defined in claim 3, wherein said light regulating member includes a support and an electrochromic material coated on said support.

5. A lens-fitted photographic film unit as defined in claim 4, said lens-fitted photographic film unit further comprising a photometric switch for turning said photometric device on and off.

6. A lens-fitted photographic film unit as defined in claim 5, said lens-fitted photographic film unit further comprising:
an electronic flash device; and
an electronic flash switch for turning said electronic flash device on and off, wherein
said controller adjusts said voltage depending on an on-state and an off-state of said electronic flash switch.
